(19) United States
(12) Patent Application Publication
(10) Pub. No.: US 2011/0313779 A1
(43) Pub. Date: Dec. 22, 2011

(54) AUGMENTATION AND CORRECTION OF LOCATION BASED DATA THROUGH USER FEEDBACK

(75) Inventors: Shai Herzog, Bellevue, WA (US); Eyal Ofek, Redmond, WA (US)

(73) Assignee: MICROSOFT CORPORATION, Redmond, WA (US)

(21) Appl. No.: 12/818,058

(22) Filed: Jun. 17, 2010

(51) Int. Cl. G06Q 30/00; G06F 3/01

(52) U.S. Cl. 705/1.1; 715/744

(57) ABSTRACT

User feedback such as “crowd sourcing” is utilized for supplementing and correcting augmented location information like augmented maps and/or street view images. User feedback on missing or incorrect information is elicited through “treasure hunt” style augmented reality games, monetary or similar rewards, and comparable incentives. Various mechanisms such as authentication of data submitting users, input from known users, image or location based confirmation from a data submitting user, and similar ones may be employed to verify the new data before or after it is published.

### BACKGROUND

Online mapping applications provide regular maps, satellite images, street view images, and similar location information. Some mapping applications augment the displayed information with relevant data like business names, addresses, and other details about specific locations. Such metadata is typically obtained from various sources like business directories, local government data sources, public web information, individuals or fleets of vehicles taking still images or video images of streets, and/or allowing business owners to provide information about their businesses. The information may also include video or audio clips, trivia, rumors, and comparable items that may be useful for people.

The accuracy of the augmentation information depends on the accuracy of data sources, depth and breadth of the data sources, update frequency of the information, and similar factors. Additionally physical structures (e.g. buildings, streets, etc.) and occupants of such structures tend to change irregularly. Directories and government records may contain older and basic information; web data is typically unstructured, information from business owners may not necessarily be reliable. Thus, gathering the information and processing it to maintain complete, up-to-date, and accurate augmentation data for mapping services is a challenging task.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to utilizing user feedback in supplementing and correcting augmented location information such as augmented maps and/or street view images. User feedback on missing or incorrect information may be elicited through “treasure hunt” style augmented reality games, monetary or similar rewards, and comparable incentives. Various mechanisms such as input from known users, image or location based confirmation from a submitting user, and similar ones may be employed to verify the new data before or after it is published.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example augmented map, where the data may be supplemented and/or corrected through verified user feedback according to embodiments;

FIG. 2 illustrates an example augmented street view, where the data may be supplemented and/or corrected through verified user feedback according to embodiments;

FIG. 3 is a conceptual diagram illustrating gathering and verification of augmentation information through user feedback;

FIG. 4 illustrates a block diagram of a system for gathering augmentation information according to some embodiments;

FIG. 5 illustrates another block diagram for a system verifying user feedback data in an augmented mapping application;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of augmentation and correction of location based data through user feedback according to embodiments.

### DETAILED DESCRIPTION

As briefly described above, user feedback such as “crowd sourcing” may be utilized for supplementing and correcting augmented location information like augmented maps and/or street view images. User feedback on missing or incorrect information may be elicited through an inverse “treasure hunt” style augmented reality games, monetary or similar rewards, and comparable incentives. The sought information is not a known detail that is hidden for the people to find, but a verification task, where the users need to find errors in the information given to them. Verification mechanisms like input from “trusted” users, image or location based confirmation from a submitting user, and similar ones may be employed to verify the new data before or after it is published. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing augmented mapping operations. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network.

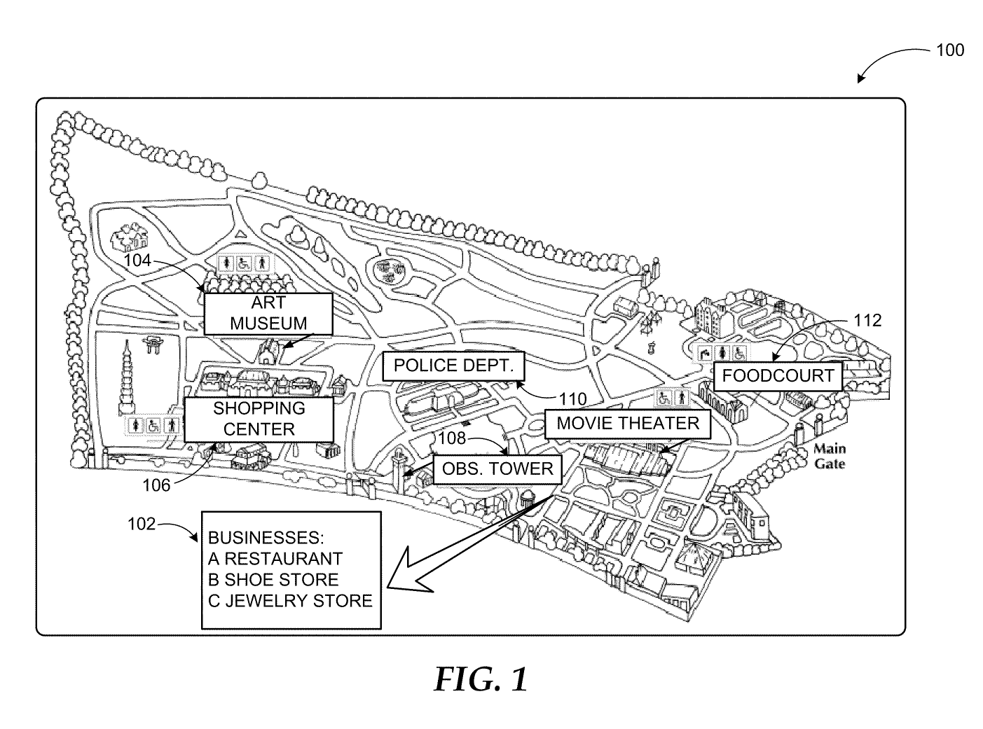

FIG. 1 illustrates an example augmented map, where the data may be supplemented and/or corrected through verified user feedback according to embodiments. Augmented reality solutions refer to an overlaying of virtual information on top of the physical/real environment. Augmented location information applications provide additional (textual or graphical) data superimposed over maps, satellite images, street view images, and the like. A street view image may include a panoramic street level view of the surroundings of a user-defined location. The location may be defined based on user input or automatic determination of the location based on Global Positioning Service (GPS) information, cellular tower triangulation, wireless data network node detection, compass, and acceleration sensors, matching of camera input to known geo-position photos, and similar methods. The augmented location information may be displayed through any computing device such as desktop computers, laptop computers, notebooks; mobile devices such as smart phones, handheld computers, wireless Personal Digital Assistants (PDAs), mapping application enabled cellular phones, vehicle mount computing devices; and similar ones.

Augmented map 100 in FIG. 1 includes several example implementations of augmented data. For example, “art museum” 104 and “observation tower” 108 are displayed as callouts pointing to particular buildings on the map. “Shopping center” 106 and “food court” 112 are displayed in hovering boxes next to the locations they correspond to. Additionally, another display box 102 provides information associated with businesses for a particular location on the map 100. Augmented information is not limited to identifying types of businesses or names of buildings. A wide variety of information about points of interest in the vicinity may be provided through augmenting location based data displays such as address details, directions, business details, contact links, historical information, dynamic data, and comparable ones. Further information may include even a text list describing the knowledge of users about a place (e.g. a list of known businesses, house numbers, historic facts, etc.).

As discussed previously, one of the challenges with augmented location displays is maintaining synchronization between augmentation data and underlying location data, especially over time. Structures and other features at a location may change over time. Occupants of buildings (e.g. businesses) may also change rendering the displayed information out-of-date. Furthermore, the original data may be obtained from an erroneous source or miscomputed (matched with a wrong location). Such errors may erode the reputation of the location based information service and the value it provides to users, yet they are hard to discover since there is typically no “authoritative source” for “reality” that can be used to identify errors.

Location based services use a variety of methods to enhance the quality of their location data. Some of the data may be obtained from multiple semi-authoritative sources like business directories or local government databases and merged. However, many of these sources are chronically out-of-date and due to high error rate even merged data may be flawed. In addition, basic information (e.g. phone number and address) is typically retrieved from such sources. Another source of information is public web data like individual business portals. However, web information is highly unstructured and typically does not provide full coverage. Some services employ individuals who examine photos of locations to identify errors or missing information, but this approach is also expensive and error prone, especially given that the employees examining photos may not be familiar with the actual locations and their subtleties. Another reason for the cost is the fact that the vendors, are typically paid by areas that they cover (representing the amount of work) and not the actual value of the data—the new data that is not known previously—they can supply. Opening the location based service to business owners or other individuals who can file errata information (missing or incorrect data) as “unverified user input”, requires initiative by business owners or other stake holders, and is open to malicious bad information.

In a system according to embodiments user feedback may be utilized for supplementing and correcting augmented location information. User feedback on missing or incorrect information may be incentivized through “inverse treasure hunt” style augmented reality games, monetary or similar rewards, and comparable incentives. Treasure hunt style games may encourage individuals and groups to seek erroneous or missing information on locations by viewing maps and other forms of location based information on their client devices and check against real locations (e.g. examine street view of a location while walking at the same location). For successful entries in such games or for direct feedback, incentives like coupons to local businesses, recognition, discounts for online purchases, access to various services, and similar inducements may be provided. To prevent erroneous or malicious entries various verification mechanisms such as input from known or “trusted” users, authentication of users providing feedback, image or location based confirmation from a submitting user (e.g. user submits a photo of the location as proof or GPS reading from the user's mobile device is retrieved along with the submission), confirmation by other users (again trusted or regular) after display of provided feedback, delaying the display of received feedback, and similar ones may be employed. It may also be possible to employ a vendor, who only has to go and confirm suggested correction. This volume of work may be significantly smaller than a full recovery of the data of an area.

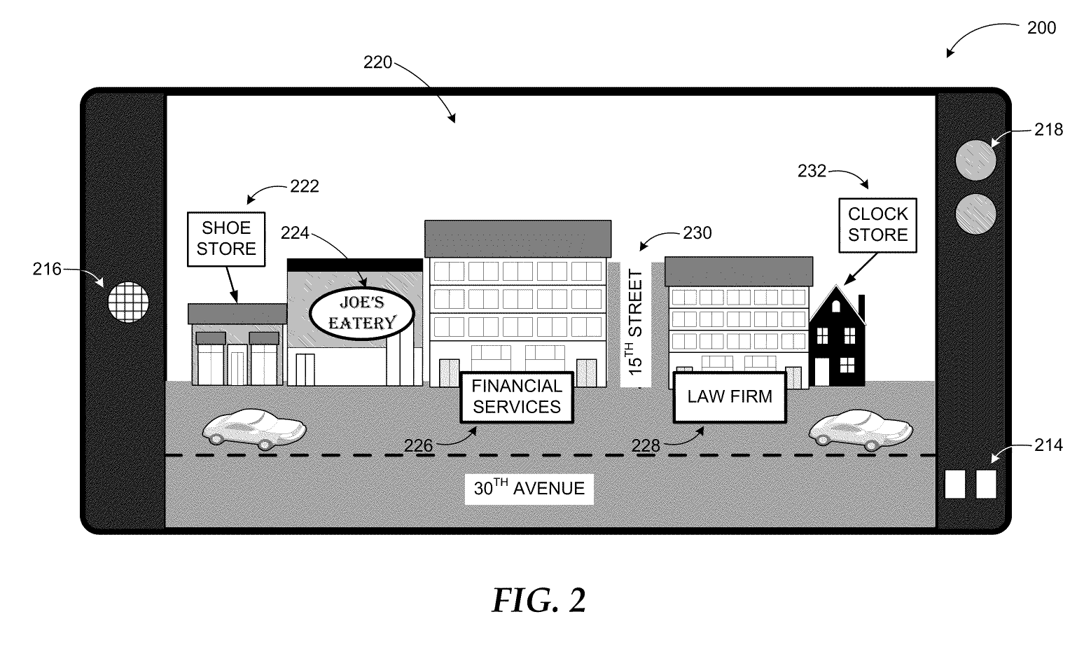

FIG. 2 illustrates an example augmented street view, where the data may be supplemented and/or corrected through verified user feedback according to embodiments. Mobile device 200 in FIG. 2 displays street view 220 of a street with several buildings and a side street. Mobile device 200 may include typical components like speaker 216, control buttons 218 and 214 for navigating through the street view 220 (or a map view).

Street view 220 includes a building with textual augmentation 222 “shoe store”, another building augmented with a stylized business logo 224 “Joe's Eatery”, a third building with textual augmentation 226 “financial services”, side street 230 “15^{th} street”, a fourth building with textual augmentation 228 “law firm”, and a fifth building with textual augmentation 232 “clock store”. Of course, other forms and types of augmentations may be used according to embodiments. For example, textual augmentations may include additional information. Graphical augmentations (icons, shapes, embedded audio/video, etc.) may also be used in conjunction with the displayed street view. As discussed above, street view 220 may not include some information associated with the building or other structures of the displayed location. Furthermore, some of the information may be incorrect or out-of-date. A mapping service according to embodiments may utilize feedback from a wide range of users to supplement missing information and correct erroneous data.

Elicitation of information from such wide spectra of users is also termed “crowd sourcing.” One approach according to embodiments may be built around a form of crowd sourcing through an augmented reality treasure hunt style game, but with a twist. Rather than searching for specific treasures, the players may search for errors and missing information. Players can walk around their neighborhoods and point a mobile device camera at all directions. When they do that, the latest virtual information may be displayed as augmented reality on their device. Players can then visually identify errors and report them (e.g. by clicking on a button, recording a snapshot of the location, or manually providing correct/missing information). The information may be uploaded to game servers and processed to produce more accurate and up-to-date information.

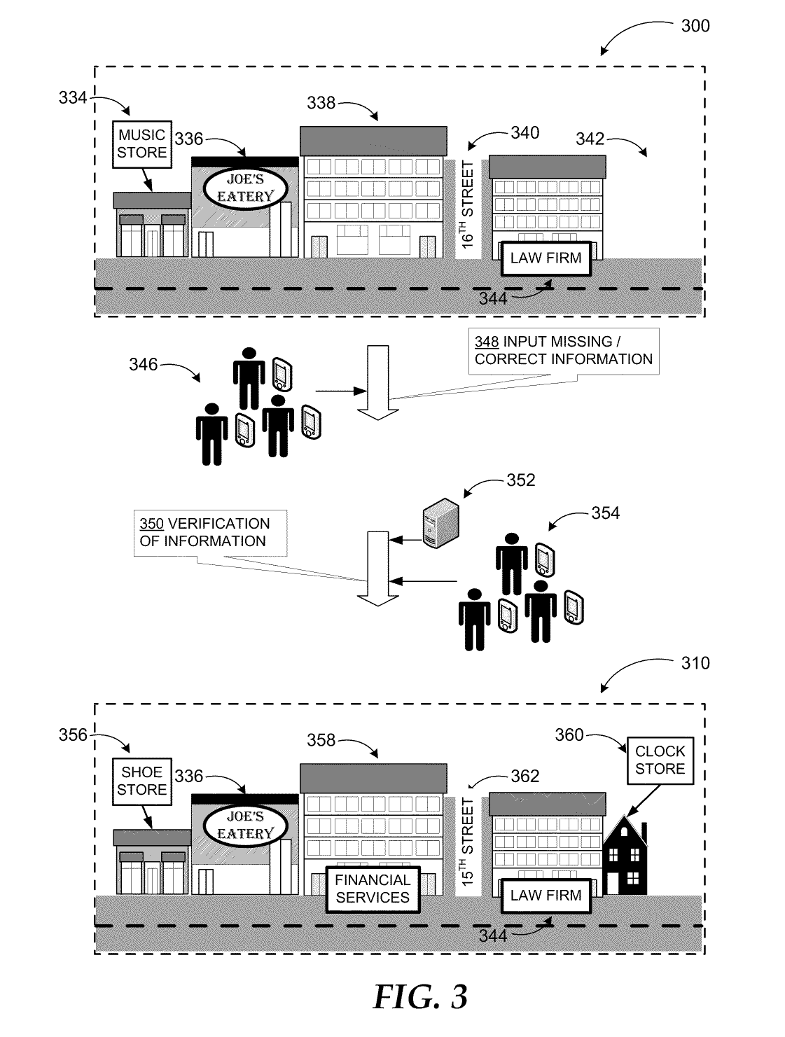

FIG. 3 is a conceptual diagram illustrating gathering and verification of augmentation information through user feedback. Diagram 300 of FIG. 3 displays a street view similar to that of FIG. 2. In an example scenario, the annotation for building 334, “music store”, and side street 340, “16^{th} street” are incorrect. Building 338 does not have an annotation, and there is an empty space 342, where a building should exist in the street view of diagram 300. Buildings 336 and 344 are augmented correctly. In the first step of a process according to embodiments, input regarding missing or incorrect information (348) is received from users 346, who may walk around the location with their handheld devices viewing the augmented reality view of the location and checking it against the real scene.

By marrying augmented reality and incentivization, crowd sourcing can be integrated into an already popular augmented reality solution (i.e. location based services) in an unobtrusive way. Assuming the augmented reality presents users with relevant data; users can identify irregularities such as information being presented at the wrong location, information being incorrect, or information for a point of interest missing. In those cases, the user may be enabled to quickly enter the correct information using mobile device sensors (e.g. camera, GPS, compass) or type it in, and send the information to the location based service.

The combined solution is akin to a treasure hunt for negative goods (errors or missing information). The user's motivation for entering the correct information may be an augmented reality reward. User's may be further motivated to engage for various reasons like volunteering for a good cause (e.g. a civic duty like increasing awareness of a city or neighborhood online), getting monetary compensation, or having a business interest in the results (e.g. a business owner wishing to correct a bad phone number that appears in his/her business listing).

As an augmented reality solution/game, users may play it and enjoy it on a normal basis even if they find little missing or erroneous information to correct. This enables finding errors even in a highly accurate system, where negative finds are few and far in between. According to some embodiments, general information or guidance may be given to the user (e.g. “you are getting closer” or “the treasure is North of you”, etc.) and used to encourage the user to capture specific areas of interest where the service has less data (or that a large number of corrections were recently found, and may signal a major change).

The second step in the process is verification of the received supplemental/corrected information (350). The verification may be performed by the service through automated procedures such as receiving a snapshot of the location with the correct or missing information from the submitting user, determining the user's location based on GPS information, authenticating the user as part of a trusted users group (e.g. users who have submitted reliable information in the past), and similar approaches. The verification may also be performed based on input from other users. For example, the service may delay publishing the update and wait to collect similar reports made by multiple independent users. During the delays, other users may be motivated to report the error or missing information, because they do not know if/when someone else already reported it. Once a predefined number of independent users report consistent data, the data may be marked as validated. If the system provides monetary incentives, they may be distributed after verification to the first user reporting the new information or first few users. Verification may also be performed by an automated system or paid testers, as the volume of correction may be smaller than the full data.

According to further embodiments, submitted information may be weighted based on number of reporting users, submitting user's trust level (based on past submissions) or indicate on the displayed map as not having been verified. Diagram 310 of FIG. 3 illustrates a corrected and completed version of the street view of diagram 300. The annotation of building 356 has been corrected as “shoe store” and side street 362 is correctly named. Building 358 is correctly identified as “financial service”, and the empty space has been correctly filled with building 360 “clock store”.

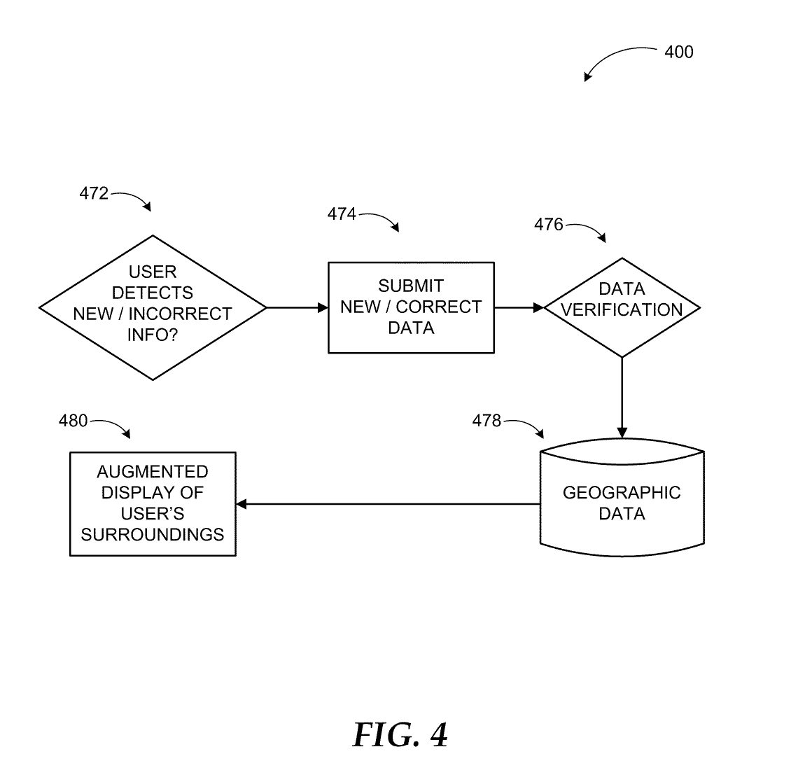

FIG. 4 illustrates a block diagram of a system for gathering augmentation information according to some embodiments. As shown in diagram 400, the augmentation and correction may begin with a user detecting new or incorrect information (472). This may be accomplished through a treasure hunt style game or at user's own initiative. The user may then submit the new or correct data (474) by providing textual input or capturing a snapshot of the location. In the latter case, an automatic text recovery algorithm may be used to identify a business name or similar information. Alternatively, the address location may be verified by crawling the business web site. Additional verification may be performed by matching image features and structures using images from multiple users. Following the data verification (476), the submission may be added to a geographic data store 478 and published (immediately or after a delay) as an augmented display of the user's surroundings (480).

As mentioned previously, rewards (monetary or otherwise) may incentivize users to submit frequently and/or with high accuracy. Rewards may include coupons, discounts, access, privileges, recognition, cash, points in a point-based reward system, revenue sharing on advertising or services that originate from or at the new data, or comparable ones. While users may be more incentivized by rapid rewarding, without verification the system may be open to abuses. Thus, a compromise solution may be implemented such as issuing an immediate non-monetary reward (e.g. credit), which is subject to verification. Also, employing fast verification methods may increase interest in the system by users.

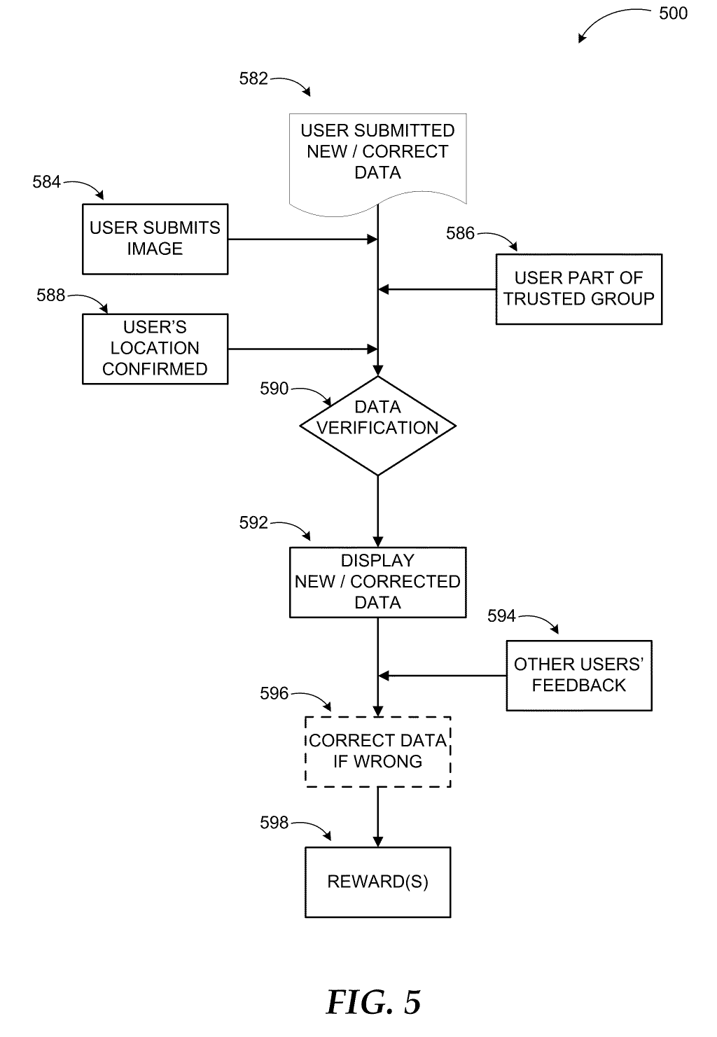

FIG. 5 illustrates another block diagram for a system verifying user feedback data in an augmented mapping application. According to diagram 500, user submitted new or correct data 582 may be subjected to verification procedures such as user submitting an image of the location 584, user's location being independently confirmed 588, or user being part of a trusted group 586. Following this round of verification (590), the new or corrected data may be displayed (592). Verification based on other users' feedback 594 may be performed in addition to the first round of verification or in place of it after the data is displayed. If the originally submitted data is found to be incorrect, it may be corrected at optional step 596, and the user submitting the correct data may be rewarded (598).

The different processes discussed in FIG. 1 through 5 such as submission of new or correct information, incentivizing users, and verification techniques may be performed at distinct hardware modules, software modules, or combinations of hardware and software. Furthermore, such modules may perform two or more of the processes in an integrated manner. While examples have been provided with specific examples for location based services providing augmented maps, satellite images, street views, etc., embodiments are not limited to location based data. Indeed, missing or incorrect information completion through user feedback may be implemented in other data systems providing collected data to users. For example, online information services providing a variety of information to web users, real time traffic information providers, and similar ones may implement a system using the principles described herein.

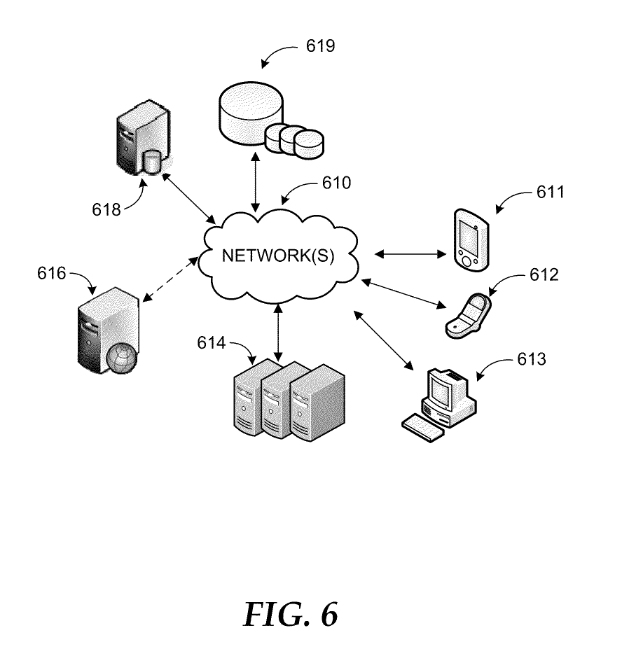

FIG. 6 is an example networked environment, where embodiments may be implemented. A platform for providing supplementation and correction for augmentation data associated with a mapping application may be implemented via software executed over one or more servers 614 such as a hosted service. The platform may communicate with client applications on individual mobile devices such as a smart phone 611, cellular phone 612, desktop computer 613, or similar devices (client devices') through network(s) 610.

Client applications executed on any of the client devices 611-613 may interact with a hosted service providing mapping services from the servers 614, or on individual server 616. The hosted service may provide augmented maps, satellite images, and/or street views. The hosted service may implement user feedback mechanisms such as reward based input, crowd sourcing, and similar ones to elicit supplemental and corrective information for stored data. Furthermore, the hosted service may also implement various verification mechanisms such as those described above. Relevant data such as street view images and supplemental textual data may be stored and/or retrieved at/from data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also include (especially between the servers and the mobile devices) cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a platform providing augmented mapping services with user feedback based correction. Furthermore, the networked environments discussed in FIG. 6 are for illustration purposes only. Embodiments are not limited to the example applications, modules, or processes.

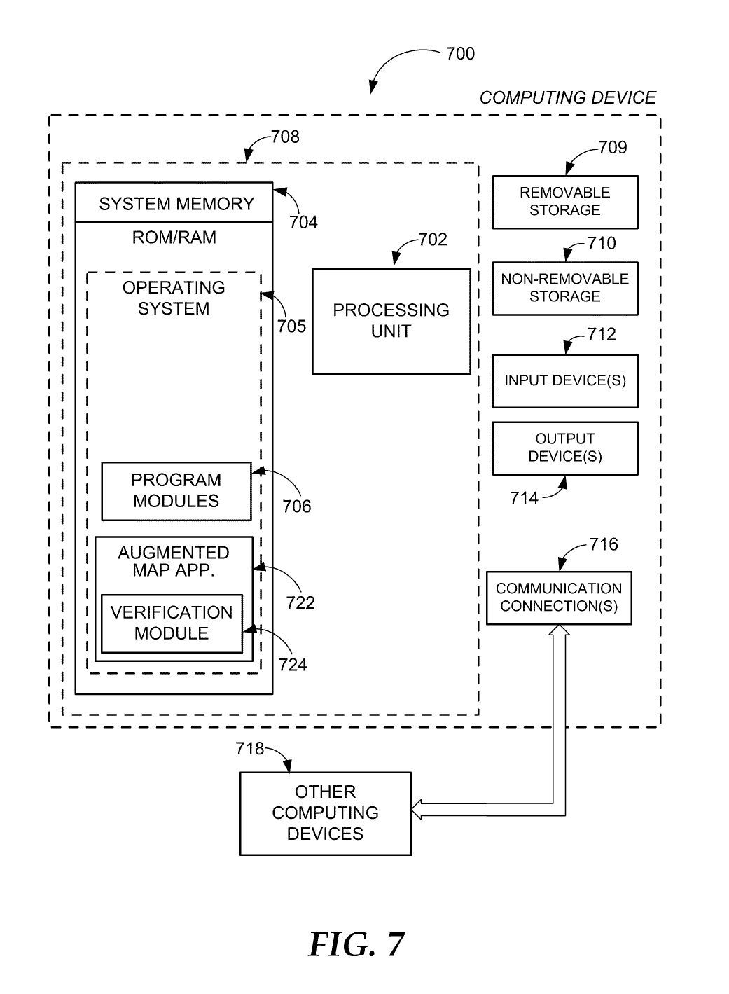

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a server capable of providing augmented mapping services according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS MOBILE® operating systems from MICROSOFT CORPORATION of Redmond, Wash. or similar ones. The system memory 704 may also include one or more software applications such as program modules 706, augmented mapping application 722, and verification module 724.

Augmented mapping application 722 may provide maps, satellite images, street view images, and similar ones augmenting them with contextual information. The augmentation data may be partially received and/or corrected through user feedback. Verification module 724 may implement various confirmation mechanisms such as confirming submitting user's location, receiving an image of the location from the user, authenticating the user, and comparable methods. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, other servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

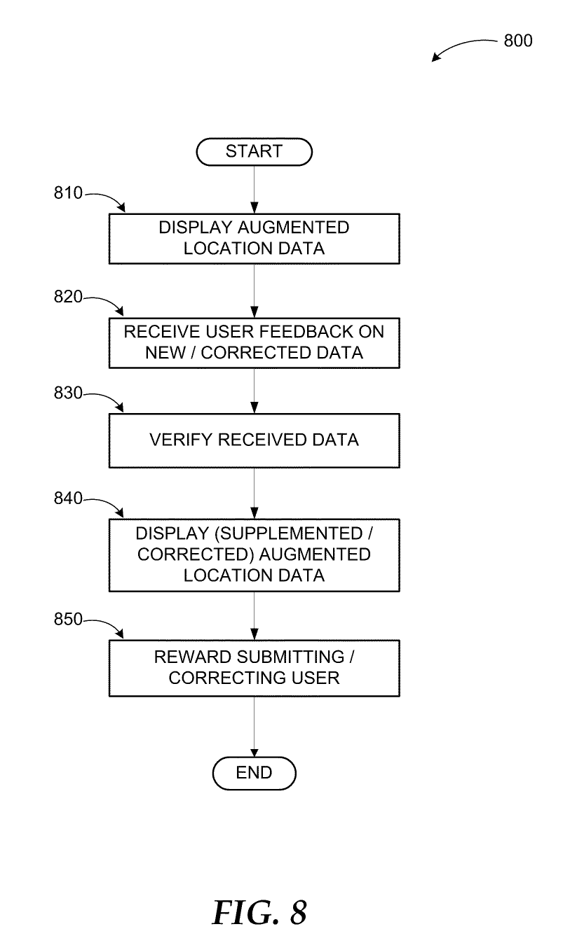

FIG. 8 illustrates a logic flow diagram for process 800 of augmentation and correction of location based data through user feedback according to embodiments. Process 800 may be implemented as part of a mapping application executed by a server.

Process 800 begins with operation 810, where augmented location data is displayed to user. The location data may include a map of the location, a satellite image of the location, a street view of the location, audio description and comparable ones. The location to be displayed may be determined based on user input or automatic computation such as based on a GPS system. At operation 820, user feedback associated with one or more features of the displayed location may be received. The feedback may include supplemental information such as a business name or detail information about a business that was not available to the mapping application. The feedback may also include correction to erroneous information. To incentivize feedback, augmented reality based treasure hunt style games or direct/indirect reward mechanisms may be employed.

At operation 830, the received feedback may be verified. The verification may take several forms. For example, only authenticated and/or trusted users may be allowed to provide feedback or feedback may be weighted based on a trust level of the providing user. Other mechanisms may include confirming a location of the user (e.g. via GPS), receiving an image of the location from the user, and the like. Some feedback mechanisms such as enabling other users to confirm or correct the received feedback may be implemented after operation 840, where the supplemented and/or corrected augmented location data is displayed.

At operation 850, the submitting or correcting user (depending on whether the initial submission was correct) may be rewarded as discussed previously. The reward mechanism may be configured to incentivize higher number and more accurate feedback and corrections. In case of corrections after display of original submitted feedback, the displayed augmented location data may be revised with the corrections and re-displayed.

The operations included in process 800 are for illustration purposes. Providing augmentation and correction of location based data through user feedback may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for supplementing and correcting augmented location based data, the method comprising:
displaying augmented location based data;
receiving user feedback associated with at least one of missing information and incorrect information in augmentation data;
verifying the user feedback;
revising the augmented location based data;
displaying the revised augmented location based data; and
rewarding a user submitting the feedback.

2. The method of claim 1, further comprising:
receiving feedback from other users after displaying the revised augmented location based data;
correcting the revised augmented location based data; and
displaying the corrected augmented location based data.

3. The method of claim 2, wherein the other users are part of a group of trusted users based on past submissions.

4. The method of claim 2, wherein the reward is a non-monetary reward subject to verification.

5. The method of claim 1, further comprising:
if a user feedback is corrected by another user, rescinding the reward to the original user submitting the feedback; and
rewarding the other user correcting the feedback.

6. The method of claim 1, further comprising:
incentivizing users to submit feedback by at least one from a set of: a “treasure hunt” style augmented reality game, advertising civic duty, advertising business interests, and rewards for direct submissions.

7. The method of claim 6, wherein the rewards include at least one from a set of: coupons, discounts, access to services, privileges, cash, and points in a point-based reward system.

8. The method of claim 1, wherein verifying the user feedback comprises at least one from a set of: authenticating a submitting user, confirming the submitting user as part of a group of “trusted users”, confirming the submitting user's location at submission time, and receiving an image of a location from the submitting user.

9. The method of claim 8, wherein the method further comprises verifying the user feedback based on one of: employing text recovery on the image received from the user and crawling a website associated with a business captured in the user submitted image.

10. The method of claim 1, wherein verifying the user feedback comprises:
delaying display of revised augmented location data until a predefined number of feedback submissions are received for the same location; and
rewarding one of: a first user to submit the verified feedback and a predefined number of users submitting the verified feedback.

11. The method of claim 1, wherein the user is enabled to submit feedback based on at least one from a set of: textual input, a camera based input, a compass based input, a touch based input, and a location based input.

12. A system for supplementing and correcting augmented location information, the system comprising:
a first server configured to host a location service providing augmented location information comprising at least one from a set of a map, a satellite image, and a panoramic street view image for a selected location;
a second server configured to host a data collection service, the data collection service adapted to:
incentivize users to submit feedback associated with the displayed augmented location information by at least one from a set of: a “treasure hunt” style augmented reality game, advertising civic duty, advertising business interests, and rewards for direct submissions;
verify user feedback based on at least one from a set of: authentication of a submitting user, confirmation of the submitting user as part of a group of “trusted users”, confirmation of the submitting user's location at submission time, feedback from other users, and receipt of an image of a location from the submitting user;
revise the augmented location information; and
display the revised augmented location information.

13. The system of claim 12, wherein the data collection service is further adapted to incentivize the user by a “treasure hunt” style augmented reality game and encourage users to submit feedback associated with an area of interest by providing guidance.

14. The system of claim 12, wherein users submitting feedback are provided with a non-monetary reward subject to verification of the feedback.

15. The system of claim 12, wherein the augmentation data includes textual information comprising at least one from a set of: an address detail, a direction, a business detail, a contact link, a historic information, and dynamic data associated with the selected location.

16. The system of claim 12, wherein the augmentation data includes graphic augmentations comprising at least one from a set of: an icon, a shape, an embedded audio file, and an embedded video file.

17. The system of claim 12, wherein the selected location is determined based on at least one from a set of: a user input through a client device, a Global Positioning Service (GPS) based input, a cellular tower triangulation based input, and a wireless data network location associated with a user.

18. A computer-readable storage medium with instructions stored thereon for supplementing and correcting augmented location information, the instructions comprising:
incentivizing users to submit feedback associated with the displayed augmented location information by at least one from a set of: a “treasure hunt” style augmented reality game, advertising civic duty, advertising business interests, and rewards for direct submissions;
verifying user feedback based on at least one from a set of: authentication of a submitting user, confirmation of the submitting user as part of a group of “trusted users”, confirmation of the submitting user's location at submission time, and receipt of an image of a location from the submitting user;
revising the augmented location information;
displaying the revised augmented location information;
if corrective feedback is received from other users associated with the revision, verifying the corrective feedback;
correcting the revised augmented location information; and
displaying the corrected augmented location information.

19. The computer-readable medium of claim 18, wherein the instructions further comprise:
rewarding a first user submitting the feedback with a non-monetary reward;
if corrective feedback is received and verified, rescinding the non-monetary reward and rewarding another user submitting the corrective feedback; else
converting the non-monetary reward for the first user to a monetary reward.

20. The computer-readable medium of claim 18, wherein user feedback is enabled by displaying the augmented location information on a mobile device with an option to submit the feedback, the option to submit the feedback comprising at least one from a set of: textual input, a camera based input, a compass based input, a touch based input, and a Global Positioning Service (GPS) based input.
